(19) United States
(12) Patent Application Publication
(10) Pub. No.: US 2011/0258055 A1
(43) Pub. Date: Oct. 20, 2011

(54) POINTS BASED SOCIAL NETWORKING WEB SITE

(76) Inventor: Joshua Abbott, Spotsylvania, VA (US)

(21) Appl. No.: 13/085,835

(22) Filed: Apr. 13, 2011

Related U.S. Application Data
(60) Provisional application No. 61/324,680, filed on Apr. 15, 2010.

(51) Int. Cl. G06Q 30/00; G06Q 99/00

(52) U.S. Cl. 705/14.73; 705/319

(57) ABSTRACT

A points-based social networking site gives its users the opportunity to earn points by viewing other profiles, inviting their friends to join the site, commenting on other profiles, viewing advertisements, and other activities on the site. The points may be referred to as popularity points. The site may rank users by the number of popularity points they earn at the social networking site. The site may allow the creation of groups for schools, universities, cities, businesses, hobbies, and the like. Users can belong to one or more groups and may be ranked within each of their groups based on their number of popularity points. In some embodiments, the present invention may be designed as a stand-alone site, having a points-based recognition system. In other embodiments, the present invention may be incorporated into an already-existing social networking site, allowing the site to recognize users by points earned.

### CROSS-REFERENCE TO RELATED APPLICATIONS

This application claims the benefit of priority of U.S. provisional patent application number 61/324,680, filed Apr. 15, 2010, the contents of which are herein incorporated by reference.

### BACKGROUND OF THE INVENTION

The present invention relates to internet-based social networking and, more particularly, to a points-based system that gives points to users of the site.

Currently, social networking sites do not accurately reflect the activity of users on the site. Current social networking sites do not give users incentive to view other profiles and advertisements on the site.

As can be seen, there is a need for a social networking site that gives users the opportunity to earn points based on the user's activity.

### SUMMARY OF THE INVENTION

In one aspect of the present invention, a points-based social networking web site comprises a database storing points of each user of the web site, the points being earned by the user by performing certain events within the web site.

In another aspect of the present invention, a computer readable medium having computer usable program code embodied therewith, the computer program code comprising computer program code configured to permit a user to join a points based web site; and computer program code configured to allow a user to earn points by performing actions on the points based web site.

In a further aspect of the present invention, a method of employing social popularity comprises incorporating a points based system in a social networking website; and ranking popularity of a user profile by comparing the points earned by a user against other users.

These and other features, aspects and advantages of the present invention will become better understood with reference to the following drawings, description and claims.

### BRIEF DESCRIPTION OF THE DRAWINGS

FIG. 1 is a flow chart describing the use of a points-based social networking site, according to an exemplary embodiment of the present invention; and

FIG. 2 is a schematic drawing of a points-based social networking site, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a points-based social networking site that gives the users the opportunity to earn points by viewing other profiles, inviting their friends to join the site, commenting on other profiles, viewing advertisements, and other activities on the site. In some embodiments, the points may be referred to as popularity points. The site of the present invention may rank users by the number of popularity points they earn at the social networking site. The site may allow the creation of groups for schools, universities, cities, businesses, hobbies, and the like. Users can belong to one or more groups and may be ranked within each of their groups based on their number of popularity points. In some embodiments, the present invention may be designed as a stand-alone site, having a points-based recognition system. In other embodiments, the present invention may be incorporated into an already-existing social networking site, allowing the site to recognize users by points earned.

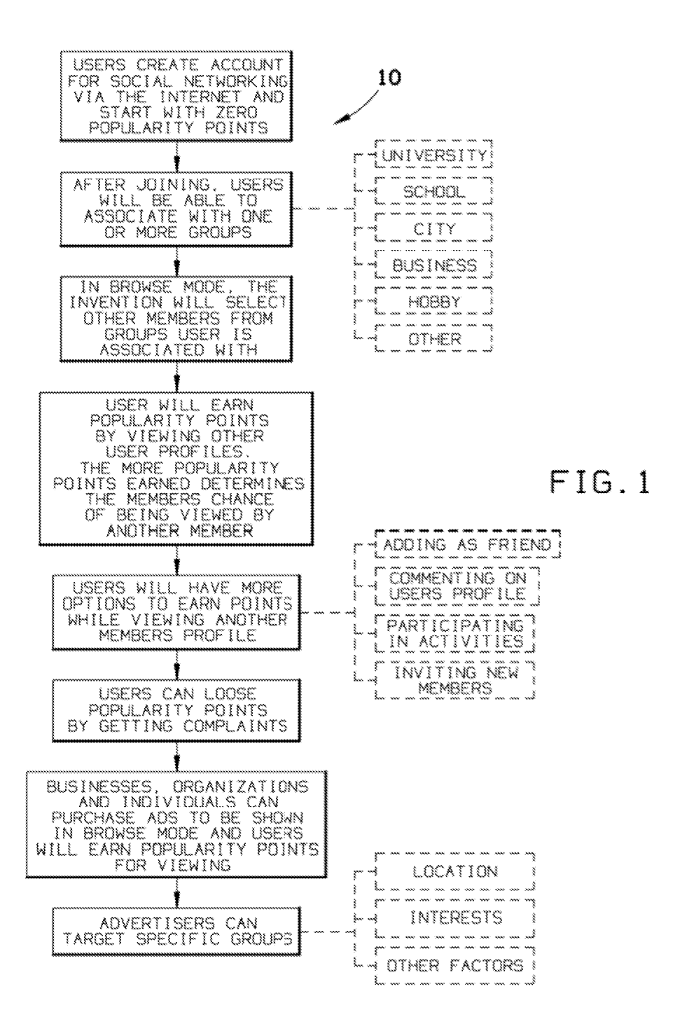

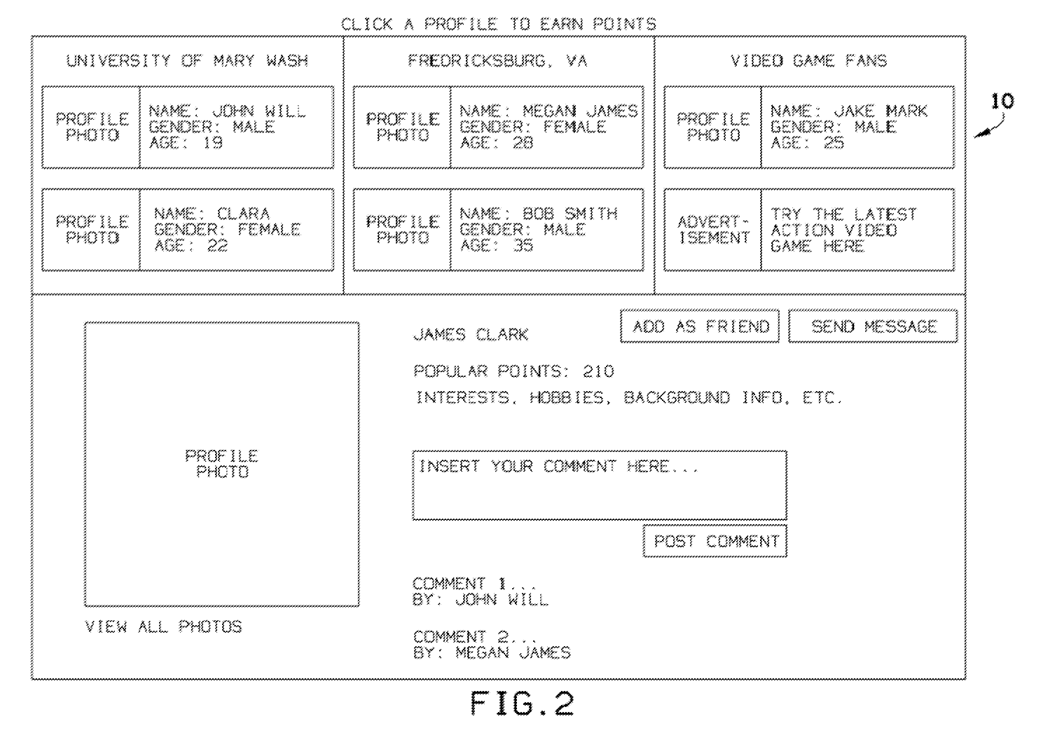

Referring to FIGS. 1 and 2, a social networking web site 10 may allow users to create an account for the site via the internet. Typically, a user may start with zero popularity points in their account. However, incentives may allow some users to open their account with a positive popularity point account balance. In some embodiments, a user of an existing social networking site may be given the opportunity to enroll their account to begin earning popularity points.

After joining the site, users will be able to associate themselves with one or more groups. A group can be, but is not limited to, a university, school, city, business or hobby. All users may be ranked within their groups by the number of popularity points they have.

The present invention (as a social networking web site or as an existing site add-in) may include a browse mode, as shown in FIG. 2, where the site may select a few other members from each group the user is associated with. By obtaining more popularity points, the member's chance of being selected for another user to see in a browse mode may increase. When a user clicks another member in browse mode, that member's profile may be loaded and shown to the user. The user may earn popularity points in exchange for viewing another member's profile, thus increasing the chance of his or her own profile being viewed by other members.

Users may have additional opportunities to earn popularity points while viewing another member's profile. Popularity points can be earned by adding them as a friend, commenting on their profile, and participating in other activities on the social networking web site. Users can also earn popularity points by inviting new members to join the social networking web site. A user can lose popularity points by exhibiting behavior that results in complaints.

Businesses, organizations and individuals may have an opportunity to purchase ads to be shown in browse mode. The ads may be rotated with other member profiles, and users may earn popularity points for viewing them. The present invention may allow advertisers to target their ads to specific groups, thus reaching a target audience by location, interest, and other factors.

The social networking web site may use a server infrastructure capable of storing and maintaining a database, while providing users with access to the service. Users accessing the service may use a personal computer or similar device, web browser and an Internet connection. The various features described above may be programmed in a programming language and stored on the social networking web site's server infrastructure. Each account and related information, including the number of popularity points, may be stored in a database within the social networking web site's server infrastructure.

It should be understood, of course, that the foregoing relates to exemplary embodiments of the invention and that modifications may be made without departing from the spirit and scope of the invention as set forth in the following claims.

What is claimed is:

1. A points-based social networking web site comprising:
a database storing points of each user of the web site, the points being earned by the user by performing certain events within the web site.

2. The web site of claim 1, further comprising one or more groups presented to the user, the user being able to join one or more of the one or more groups.

3. The web site of claim 2, wherein the users are ranked within each group of which the user has joined according to the number of points of the user relative to the number of points of other users of each group.

4. The web site of claim 1, wherein the users are ranked according to the number of points of the user relative to all the other users of the web site.

5. A computer readable medium having computer usable program code embodied therewith, the computer program code comprising:
computer program code configured to permit a user to join a points based social networking web site; and
computer program code configured to allow a user to earn points by performing actions on the points based web site.

6. The computer readable medium of claim 5, wherein the computer program code further comprises computer program code enabling the user to associate with one or more groups.

7. The computer readable medium of claim 5, wherein the computer program code further comprises computer program code offering a browse mode, wherein the browse mode displays other members from the groups the user is associated with.

8. The computer readable medium of claim 5, wherein the actions include viewing other user's profiles, viewing advertisements, commenting on other user's profiles, and adding another user as a friend.

9. The computer readable medium of claim 7, wherein the computer program code further comprises computer program code permitting businesses, organizations and individuals to purchase ads to be shown in the browse mode.

10. A method of employing social popularity, comprising:
incorporating a points based system in a social networking website; and
ranking popularity of a user profile by comparing the points earned by a user against other users.
